(19) United States
(12) Patent Application Publication
(10) Pub. No.: US 2006/0264550 A1
(43) Pub. Date: Nov. 23, 2006

(54) Non-infringment composition

(76) Inventor: Maurizio Porcelli, Bergamo (IT)

Correspondence Address: NIXON & VANDERHYE, PC, 901 NORTH GLEBE ROAD, 11TH FLOOR, ARLINGTON, VA, 22203, US

(21) Appl. No.: 10/554,909

(22) PCT Filed: May 19, 2004
(86) PCT No.: PCT/IT04/00281

§ 371 Date: Nov. 18, 2005

(51) Int. Cl. C08K 3/22

(52) U.S. Cl. 524/430

(57) ABSTRACT

The subject of the present invention is a composition with a plastic-material base, which comprises at least one resin chosen from amongst acetate resins, polyester resins, melamine resins, urea-formaldehyde resins, polyamide resins and ABS and at least one derivative compound of at least one element chosen from Fe, Al, Sn, In, Ti, Zn, a process for its preparation, use of the composition for the preparation of finished products designed to be used in association with articles of various kinds, for example in the clothing or furnishing sectors. Also forming the subject of the present invention is an apparatus designed to be used in association with the aforesaid finished product and/or article for the detection of certain standard parameters.

### SUBJECT OF THE INVENTION

The subject of the present invention is a composition based on a plastic-material, a process for its preparation, use of the composition for the preparation of finished products designed to be used in association with articles of various kinds, for example in the clothing or furnishing sectors. Also forming the subject of the present invention is an apparatus designed to be used in association with the aforesaid finished product and/or article for detection of certain standard parameters.

### STATE OF THE ART

As is known, the problem of counterfeiting and imitation is very much felt in all manufacturing sectors, but in particular it assumes a fundamental importance in those sectors in which the finished product is sold to the general public at accessible prices and belongs to sectors of consumer goods, such as for example the clothing sector, the furnishing sector, and the like.

In these sectors, in fact, the non-authorized reproduction of a product or an object performed by other parties that do not act according to the specifications and on the basis of an authorization of the creator of the object itself is very frequent, above all in the cases where the object reproduced is a trendy object.

For example, in the fashion sector, there is frequent reproduction of various objects, for example a bag or a pair of shoes or a furnishing element that was initially created by a specific producer. In the case where the object meets with a certain success or is trendy, it is rapidly reproduced by other non-authorized parties and put on the market at prices that are very often significantly lower than the original, with evident detriment to the creator and/or authorized producer of the object itself. Normally, the object reproduced in a non-authorized way is made with less care and is of a lower quality. Frequently, however, these characteristics escape notice at first sight and, above all in more recent times, cannot be noted even upon a closer initial examination. Furthermore, sometimes the products made in a non-authorized way are of excellent quality, and it is difficult, even upon a careful examination, to recognize their origin. There exist systems developed recently for distinguishing so-called “original” products, i.e., ones manufactured by and/or with the authorization of the creator and/or the original producer, for example using devices based upon microchips or transponders, but said systems present a number of drawbacks. In fact, such systems are costly, difficult to personalize, and frequently call for the insertion of the device at a stage subsequent to the normal fabrication of the article to be distinguished, with corresponding additional costs.

### OBJECTS OF THE INVENTION

The object of the present invention is to make available a composition based on a plastic material that will enable its utilization for the preparation of finished products designed to be used in association with articles of various kinds, for example in the clothing or furnishing sectors and that will enable identification in a unique way of the origin of said articles.

A further object of the present invention is to make available a process for the preparation of the aforesaid composition which will consist of just a few steps, will be fast and will furnish an advantageous product from the economic standpoint.

Yet another object of the invention is to make available a product designed to be associated with articles of various kinds, for example in the clothing or furnishing sectors and that will enable identification in a unique way of the origin of said articles and will be advantageous from the economic standpoint.

Yet a further object of the present invention is to make available on apparatus that will enable standard detection of the product, possibly associated with the finished article obtained with the composition according to the invention, thus making it possible to retrace, in a unique way, the origin of the article in question.

Finally, an object of the present invention is to make available an article that is provided with the product obtained using the composition according to the invention.

### DESCRIPTION

The above and yet other object, as well as the corresponding advantages that will be illustrated in greater detail in the ensuing description are achieved by a composition that comprises at least one resin chosen from among acetate resins, polyester resins, melamine resins, urea-formaldehyde resins, polyamide resins and ABS and at least one derivative compound of at least one element chosen from: Fe, Al, Sn, In, Ti, Zn.

According to the present invention, said at least one resin is urea-formaldehyde resin, and said at least one element is chosen from between Al and Fe.

More in particular, said derivative compound of Fe, Al, Sn, In, Ti, Zn is a salt, a complex, or an oxide of said element, for example an oxide chosen from the group: Fe₂O₃, Al₂O₃, SnO, InO, TiO₂, ZnO. Again according to the invention, said compound is advantageously chosen from between Fe₂O₃ and Al₂O₃.

The composition according to the invention, which comprises at least one resin chosen from amongst acetate resins, polyester resins, melamine resins, urea-formaldehyde resins, polyamide resins and ABS and at least one derivative compound of at least one element chosen from the group Fe, Al, Sn, In, Ti, Zn, is indicated, for reasons of simplicity, as basic composition and can of course further comprise fillers and additives of a known type, such as for example plastifiers, potato flour, powdered horn, and the like.

Advantageously, the basic composition envisages that the resin will be present in amounts ranging between 30 wt % and 90 wt % with respect to the total weight of the end composition, preferably comprised between 45 wt % and 75 wt % and in particular comprised between 60 wt % and 70 wt % with respect to the total weight of the end composition. Again according to the present invention, the basic composition envisages that said derivative compound of at least one element chosen from: Fe, Al, Sn, In, Ti, Zn will be present in amounts ranging between 0.05 wt % and 10 wt % with respect to the total weight of the end composition, preferably comprised between 0.05 wt % and 5 wt % and, in particular, comprised between 0.1 wt % and 1 wt % with respect to the total weight of the end composition. The composition according to the present invention is prepared using a process which comprises the following steps:
a) mixing said at least one resin chosen from among acetate resins, polyester resins, melamine resins, urea-formaldehyde resins, polyamide resins and ABS, and extenders, additives, fillers to obtain a mixed powder;
b) adding and mixing said at least one derivative compound of at least one element chosen from: Fe, Al, Sn, In, Ti, Zn to said mixed powder to obtain a basic mix; and
c) treating said basic mix according to known techniques to obtain finished products of different kinds, according to the use to which they are to be put.

The process described above is used in the case where a dry basic mix is required. Alternatively, it is possible to produce a wet basic mix by inserting between said step a) and said step b) an intermediate step ab) which requires the addition of the necessary liquid components.

Using the composition according to the invention it is possible to prepare finished products, for example buckles, buttons, pins, screws, joints, labels, inserts made of suitable material, name-plates, and the like, which may be associated, in a simple way, to articles of various kinds, for example articles of the clothing or furnishing sectors. Said products, once they are associated to said articles, enable identification in a unique way of the origin of the articles themselves. In fact, the composition according to the invention comprises, at different concentrations, at least one derivative of at least one of said elements, Fe, Al, Sn, In, Ti, Zn, which is characterized by a resonance frequency that can be detected by suitable apparatus. In practice, to provide an example in no way limiting the scope of the present invention, the composition according to the invention is used for the preparation of a series of buttons. The aforesaid buttons are associated to a garment, for example a jacket, of which it is intended to identify and be able to verify the origin. The authorized producer of the jacket, or the creator of the model, decides that at least one of the buttons applied on the jacket will be made using the composition according to the invention. Should it be necessary to check jackets that are apparently the same but where the origin thereof is in question, it will be sufficient to check the jackets using the appropriate apparatus, which also forms the subject of the present invention. It will thus appear immediately evident that the response detected for the original jackets, i.e., ones provided with at least one button obtained via the composition object of the invention, will differ from that of the non-original jackets, which will have all buttons of a traditional type and, hence, will yield a different response. It will thus be immediately possible to distinguish the original jackets from the non-original ones reproduced without authorization.

The official producer for example of a certain signed or stamped garment can thus decide to apply any accessory produced using the composition forming the subject of the invention to said garment. By means of the detector, the producer is in all cases able to establish whether it is his own original garment or a non-authorized copy. In addition, since it is possible to vary the degree of concentration of the resonant element in the raw material, i.e., in the composition, it is possible for the producer to establish to which season/production lot the garment belongs, as well as to safeguard himself from possible further imitations that manage to retrace the previous resonant concentration.

The products obtained using the compositions according to the invention, are suitable for being associated, according to various modalities, to articles widely available on the market which require checks in regard to their possible imitations. As has already been said, the products obtained via the compositions according to the invention are, for example, buckles, buttons, name-plates, labels, screws, small chains, joints, and the like. The product is obtained by adding to the basic resin predefined and variable amounts of at least one derivative of the aforesaid elements. Using suitable apparatus and/or an appropriate verification tool, it is therefore possible to identify precisely, reliably and confidentially the particular production lot, and consequently the origin and originality of the article in which said product is inserted or to which it is associated.

The solution according to the invention presents numerous advantages.
The system is economically advantageous as compared to the conventional systems currently adopted and hence proves competitive.
The basic composition can be rapidly modified and even agreed upon with the customer who is the manufacturer of the finished article, without the appearance of the product and hence the article being in any way modified.
It is possible to personalize the product and hence adapt it to each article to which it is to be associated.
Application of the product on the finished article can normally be performed using the same production machinery normally employed without any additional expenses. For example, in the case where the products are buttons to be applied to clothing articles, all the buttons will be applied when the articles are made, i.e., both the “normal” buttons and the buttons made using the composition forming the subject of the present invention, will be applied at the same time without, for example, the maker being able to distinguish the accessory that will enable control and verification of the garment. At present, for example in the case of buttons, a transponder is inserted in just one button that is applied subsequently on the garment, thus creating one variable more with respect to the possibility of the garment being reproduced in a non-authorized way.
Protection of the garment is in effect “invisible”, in so far as it is not possible to distinguish the button, or other product obtained using the composition according to the invention, from another similar product made using traditional techniques.
It is very difficult to analyse the product and to trace back to the type of derivative utilized and to its exact composition, and hence it is extremely difficult to reproduce the product without due authorization.

A suitable piece of equipment apparatus for detecting the product according to the invention is based upon the physical principle, used in the verification system, which, in brief, consists in measuring the decay of the residual currents induced in the metal parts (decay of Foucault currents). Notwithstanding the very small amounts of current involved in the signal measured, a series of appropriate solutions applied enable measurements that are reliable, repetitive and useful for a reliable identification of the article and of the period of manufacture thereof.

By way of non-limiting example of the present invention, there follows a detailed description of a process for preparing a product in the form of a button, using the composition according to the invention.

### EXAMPLE 1

The finished product, in this case a button, is obtained via the following steps:
Obtaining the basic composition, to which there is added a resonant element:
   a) Using a dosing system, the following raw materials are weighed:
      Urea-formaldehyde resin for moulding (with a urea-formaldehyde and cellulose base)
      Urea-formaldehyde resin without cellulose filler
      Potato flour
      Powdered horn
   ab) The powders are conveyed pneumatically to the paste-mixer, where there are added, after prior dosing, the following ingredients:
      Diethylene glycol
      Water
      Hardener
      At the end of the paste-mixer operating cycle, the material is discharged and set on trolleys for conveyance to a second series of fork mixers to obtain a neutral paste.
   b) Said neutral paste is inserted into fork mixers with the addition of ingredients that are to be dispersed for a period that can vary according to the amount of paste involved. These ingredients are the ones that will be subsequently sought using suitable instrumentation, and in particular are derivative compounds of at least one element chosen from the group: Fe, Al, Sn, In, Ti, Zn.
Colouring the paste thus prepared in amounts according to the subsequent preparation of the unit in question.
Following a sequence of manipulation of the coloured paste in order to reproduce a working drawing (staining of the button) to obtain finally a coloured mould having a cylindrical shape that must be embedded in polythene to prevent loss of water by evaporation.
Hardening the cylinder thus protected for example at a temperature of 48° C. for 24 hours in order to render it suitable for drawing.
Drawing the mould into preforms—rounds of different diameters and cut, with unit weights different according to the desired button via drawplate controlled by on-board PLCs.
Eliminating a percentage of water through the step of drying in ovens at controlled temperature and humidity with a cycle of 48 hours.
Separating the preforms via shaking.
Moulding the preforms, for example at 150° C., using presses capable of exerting pressures of 200 bar/cm² to obtain, after variable times, the buttons or the semifinished products required.
Removing the moulding burrs by means of tumbling barrels and subsequently of scalpers.
Performing subsequent machining operations to obtain the desired articles.
Carrying out a final check on the products and a verification via suitable equipment of the correct response value of the data agreed upon with the customer.

### EXAMPLE 2

Basic Composition:

40 wt % of urea-formaldehyde resin with cellulose fillers

30 wt % of urea-formaldehyde resin

2 wt % of powdered horn

6.2 wt % of potato flour

20 wt % of water

1.6 wt % of diethylene glycol

0.2 wt % of glycerine

To said basic composition there is added 0.2 wt % of Fe₂_{O}₃+0.75 wt % of Al₂O₃.

### EXAMPLE 3

Basic Composition:

15 wt % of urea-formaldehyde resin with cellulose fillers

45 wt % of urea-formaldehyde resin

25 wt % of powdered horn

13.8 wt % of water

1.0 wt % of diethylene glycol

0.2 wt % of glycerine

To said basic composition there is added 2 wt % of TiO₂+0.15 wt % of InO.

### EXAMPLE 4

Basic Composition:

44 wt % of urea-formaldehyde resin with cellulose fillers

27 wt % of urea-formaldehyde resin

2 wt % of powdered horn

5.2 wt % of potato flour

20 wt % of water

1.6 wt % of diethylene glycol

0.2 wt % of glycerine

To said basic composition there is added 1 wt % of ZnCO₃+1.75 wt % of Al₂O₃.

### EXAMPLE 5

Basic Composition:

60 wt % of urea-formaldehyde resin with cellulose fillers

10 wt % of melamine resin

10 wt % of potato flour

18 wt % of water

1.6 wt % of diethylene glycol

0.4 wt % of glycerine

To said basic composition there is added 0.5 wt % of SnO+0.5 wt % of ZnO.

1. A composition that comprises at least one resin chosen from among acetate resins, polyester resins, melamine resins, urea-formaldehyde resins, polyamide resins and ABS, and at least one derivative compound of at least one element chosen from the group: Fe, Al, Sn, In, Ti, and Zn.

2. The composition according to claim 1, characterized in that said at least one resin is urea-formaldehyde resin and said at least one element is selected from Al and Fe.

3. The composition according to claim 1, characterized in that said derivative compound of Fe, Al, Sn, In, Ti, Zn is a salt, a complex or an oxide of said element.

4. The composition according to claim 3, characterized in that said derivative compound is chosen from the group: Fe₂O₃, Al₂O₃, SnO, InO, TiO₂, and ZnO.

5. The composition according to claim 4, characterized in that said compound is selected from Fe₂O₃ and Al₂O₃.

6. The composition according to claim 1, characterized in that it further comprises fillers and additives of a known type, such as, plastifiers, potato flour, powdered horn.

7. The composition according to claim 1, characterized in that said resin is present in amounts ranging between 30 wt % and 90 wt % with respect to the total weight of the end composition.

8. The composition according to claim 1, characterized in that said resin is present in amounts ranging between 45 wt % and 75 wt % with respect to the total weight of the end composition.

9. The composition according to claim 1, characterized in that said resin is present in amounts ranging between 60 wt % and 70 wt % with respect to the total weight of the end composition.

10. The composition according to claim 1, characterized in that said derivative compound of at least one element chosen from Fe, Al, Sn, In, Ti, Zn is present in amounts ranging between 0.05 wt % and 10 wt % with respect to the total weight of the end composition.

11. The composition according to claim 1, characterized in that said derivative compound of at least one element chosen from the group Fe, Al, Sn, In, Ti, Zn is present in amounts ranging between 0.05 wt % and 5 wt % with respect to the total weight of the end composition.

12. The composition according to claim 1, characterized in that said derivative compound of at least one element chosen from the group Fe, Al, Sn, In, Ti, Zn is present in amounts ranging between 0.1 wt % and 1 wt % with respect to the total weight of the end composition.

13. A process for the preparation of a composition according to claim 1, which comprises the following steps:
a) mixing said at least one resin chosen from among acetate resins, polyester resins, melamine resins, urea-formaldehyde resins, polyamide resins and ABS, and extenders, additives, fillers, to obtain a mixed powder;
b) adding and mixing said at least one derivative compound of at least one element chosen from Fe, Al, Sn, In, Ti, Zn to said mixed powder, to obtain a basic mix; and
c) treating said basic mix according to known techniques to obtain finished products of different kinds, according to the use to which they are to be put.

14. The process according to claim 13, characterized in that it is used to obtain a dry basic mix.

15. The process according to claim 13, characterized in that it is used to obtain a wet basic mix, via insertion between said step a) and said step b) of an intermediate step ab), which envisages the addition of the necessary liquid components.

16. The process according to claim 13, characterized in that it comprises the following steps:
Obtaining the basic composition, to which there is added said at least one element chosen from Fe, Al, Sn, In, Ti, Zn:
a) mixing of:
Urea-formaldehyde resin for moulding (based on urea-formaldehyde and cellulose)
Urea-formaldehyde resin without cellulose filler
Potato flour
Powdered horn
ab) addition of:
Diethylene glycol
Water
Hardener
to obtain a neutral paste
c) Insertion of said neutral paste in fork mixers with addition of at least one derivative compound of at least one element chosen from: Fe, Al, Sn, In, Ti, Zn.

17. Use of the composition according to claim 1 for the preparation of products designed to be associated with articles of various kinds.

18. Use according to claim 17, where said products are buttons.

19. Use according to claim 17, where said products are buckles, pins, screws, joints, labels, name-plates, inserts.

20. A product designed to be associated with articles of various kinds obtained using the composition referred to in claim 1.

21. A process for the preparation of a product according to claim 19, characterized in that it comprises the following steps:
Colouring a paste to obtain a coloured paste;
Following a sequence of manipulation of the coloured paste in order to reproduce a working drawing to obtain finally a coloured mould having a cylindrical shape
Hardening
Drawing of the mould into preforms—rounds of different diameters
Eliminating a percentage of water via the step of drying in ovens at controlled temperature and humidity
Separating the preforms
Moulding the preforms to obtain buttons, other semifinished products, or the required products
Removing the moulding burrs
Carrying out subsequent machining operations to obtain the desired products.

22. Use of at least one product referred to in claim 19 for the making/finishing of finished articles.

23. Finished articles that comprise in association/union at least one product referred to in claim 19.

24. Apparatus suited for detecting at least one derivative compound of at least one element chosen from: Fe, Al, Sn, In, Ti, Zn according to the composition referred to in claim 1.

25. The composition according to claim 1, characterized in that it comprises:
40 wt % of urea-formaldehyde resin with cellulose fillers
30 wt % of urea-formaldehyde resin
2 wt % of powdered horn
6.2 wt % of potato flour
20 wt % of water
1.6 wt % of diethylene glycol
0.2 wt % of glycerine
0.2 wt % of Fe₂O₃
0.75 wt % of Al₂O₃.

26. The composition according to claim 1, characterized in that it comprises:
15 wt % of urea-formaldehyde resin with cellulose fillers
45 wt % of urea-formaldehyde resin
25 wt % of powdered horn
13.8 wt % of water
1.0 wt % of diethylene glycol
0.2 wt % of glycerine
2 wt % of TiO₂
0.15 wt % of InO.

27. The composition according to claim 1, characterized in that it comprises:
44 wt % of urea-formaldehyde resin with cellulose fillers
27 wt % of urea-formaldehyde resin
2 wt % of powdered horn
5.2 wt % of potato flour
20 wt % of water
1.6 wt % of diethylene glycol
0.2 wt % of glycerine
1 wt % of ZnCO₃
1.75 wt % of Al₂O₃.

28. The composition according to claim 1, characterized in that it comprises:
60 wt % of urea-formaldehyde resin with cellulose fillers
10 wt % of melamine resin
10 wt % of potato flour
18 wt % of water
1.6 wt % of diethylene glycol
0.4 wt % of glycerine
0.5 wt % of SnO
0.5 wt % of ZnO.
